(19) United States
(12) Patent Application Publication
(10) Pub. No.: US 2019/0387656 A1
(43) Pub. Date: Dec. 26, 2019

(54) MARKER ARM SPRING RETAINER

(71) Applicant: CNH Industrial America LLC, New Holland, PA (US)

(72) Inventors: Brent Elwing, Roselle, IL (US); Brian J. Anderson, Yorkville, IL (US); Chad M. Johnson, Arlington Heights, IL (US); Travis L. Harnetiaux, Bourbonnais, IL (US); Johnathon R. Dienst, DeKalb, IL (US); Patrick Dinnon, Plainfield, IL (US); Michael J. Connors, Lockport, IL (US)

(73) Assignee: CNH Industrial America LLC, New Holland, PA (US)

(21) Appl. No.: 16/018,844

(22) Filed: Jun. 26, 2018

(51) Int. Cl. A01B 73/02; A01B 69/02

(52) U.S. Cl. CPC A01B 73/02; A01B 69/024

(57) ABSTRACT

An implement for an agricultural vehicle including a toolbar and a pair of marking devices pivotally connected to the toolbar. Each marking device includes a first arm, a second arm, and a first attachment bracket pivotally connecting the first arm to the distal end of the second arm. The first and second arms are configured for pivoting between a stored position in which the first and second arms are folded relative to one another and an operational position in which the first and second arms are unfolded relative to one another. Each marking device further includes a second attachment bracket, a kick out link, and a biasing member connected to the kick out link and configured for providing a biasing force acting on the kick out link to retain the first arm relative to the second arm in the stored position.

### FIELD OF THE INVENTION

The present invention pertains to implements for an agricultural vehicle and, more specifically, to implements having marker arms.

### BACKGROUND OF THE INVENTION

Agricultural planters are commonly used implements to plant seeds in soil. An agricultural planter can include a chassis that carries seed and/or chemical storage tanks, a hitch mechanism that attaches to a tractor or other implement pulled by a tractor, a toolbar, and row units attached to the toolbar. The planter can also include a pneumatic system carried by the chassis that supplies pressurized air to transport the seeds or other particulate from the storage tanks to the row units. The planter may additionally include marking devices in the form of a marking disc and one or more marker arm(s) connected to the lateral ends of the toolbar. The marking devices can be automatically and individually raised and lowered by a respective lift assembly, such as a hydraulic cylinder. The marking devices create a line, e.g. a furrow, in the field which illustrates a marker of the position of the planter as it traverses the field. This marker can be used by the operator to more easily align the planter during subsequent passes down the field. Thereby, the operator can properly align the planter so that the planter does not reseed an area or create a gap between a previously planted row and a new row. The marker arms of the marking devices can be folded into a stored position in which the arms rest on top of the toolbar or unfolded into an operational position in which the marking devices can mark a line in the field.

Generally, the outer marker arms have the ability to swing freely in the stored position. Thereby, the outer marker arms can become unfolded when the planter undergoes certain movements, for example, when the planter tilts up and down or side-to-side, performs fast end-of-field turns, and/or suddenly stops. If the outer marker arms undesirably unfold out of their respective stored positions, the outer marker arms may hit and damage another structure, such as the seed tanks, chemical tanks, trees, etc. Still further, the undesirable unfolding of the outer marker arms can result in damage to the outer marker arms themselves.

What is needed in the art is a cost-effective device to secure the marker arms in their respective stored positions.

### SUMMARY OF THE INVENTION

In one exemplary embodiment formed in accordance with the present invention, there is provided an agricultural planting implement that includes a pair of marking devices which each have springs attached to respective kick out links. The springs retain the outer arms in their stored positions such that the outer arms do not undesirably unfold without actuation of their respective actuators.

In another exemplary embodiment formed in accordance with the present invention, there is provided an implement for an agricultural vehicle including a toolbar and a pair of marking devices pivotally connected to the toolbar. Each marking device includes a first arm, a second arm having a proximal end and a distal end, and a first attachment bracket pivotally connecting the first arm to the distal end of the second arm. The first and second arms are configured for pivoting between a stored position in which the first and second arms are folded relative to one another and an operational position in which the first and second arms are unfolded relative to one another. Each marking device further includes a second attachment bracket supported by the toolbar and positioned adjacent to the proximal end of the second arm, and a kick out link pivotally interconnected between the first attachment bracket and the second attachment bracket. The kick out link is configured for controlling a movement of the first arm. Each marking device further includes a biasing member connected to the kick out link and configured for providing a biasing force acting on the kick out link to retain the first arm relative to the second arm in the stored position.

In yet another exemplary embodiment formed in accordance with the present invention, there is provided a marking device pivotally connected to an implement for an agricultural vehicle. The marking device includes a first arm, a second arm having a proximal end and a distal end, and a first attachment bracket pivotally connecting the first arm to the distal end of the second arm. The first and second arms are configured for pivoting between a stored position in which the first and second arms are folded relative to one another and an operational position in which the first and second arms are unfolded relative to one another. The marking device also includes a second attachment bracket positioned adjacent to the proximal end of the second arm, and a kick out link pivotally interconnected between the first attachment bracket and the second attachment bracket. The kick out link is configured for controlling a movement of the first arm. The marking device further includes a biasing member connected to the kick out link and configured for providing a biasing force acting on the kick out link to retain the first arm relative to the second arm in the stored position.

In yet another exemplary embodiment formed in accordance with the present invention, there is provided a method including the step of providing an implement for an agricultural vehicle including a toolbar and a pair of marking devices pivotally connected to the toolbar. Each marking device includes a first arm, a second arm having a proximal end and a distal end, and a first attachment bracket pivotally connecting the first arm to the distal end of the second arm. The first and second arms are configured for pivoting between a stored position in which the first and second arms are folded relative to one another and an operational position in which the first and second arms are unfolded relative to one another. Each marking device also includes a second attachment bracket supported by the toolbar and positioned adjacent to the proximal end of the second arm, and a kick out link pivotally interconnected between the first attachment bracket and the second attachment bracket. The kick out link is configured for controlling a movement of the first arm. Each marking device further includes a biasing member connected to the kick out link and configured for providing a biasing force acting on the kick out link. The method also includes the steps of biasing, by the biasing member, the kick out link to not slide in order to retain the first arm relative to the second arm in the stored position, and overcoming, by the kick out link, the biasing force provided by the biasing member upon selecting to unfold a respective marking device to be in the operational position.

One possible advantage of the exemplary embodiment of the agricultural implement is that the marking devices do not undesirably unfold out of the stored position, and thereby any damage which would have been caused by the outer arm contacting the various tanks and components of the agricultural implement are prevented.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown Like numerals indicate like elements throughout the drawings. In the drawings:

FIG. 1 illustrates a perspective view of an exemplary embodiment of a planter, the planter including a pair of marking devices, in accordance with an exemplary embodiment of the present invention;

FIG. 2 illustrates the biasing member of a respective marking device of the planter of FIG. 1, in accordance with an exemplary embodiment of the present invention;

FIG. 3 illustrates a bottom perspective view of the biasing member of a respective marking device of the planter of FIG. 1, in accordance with an exemplary embodiment of the present invention;

FIG. 4 illustrates a perspective view of the marking device in a folded, stored position, in accordance with an exemplary embodiment of the present invention; and

FIG. 5 illustrates a perspective view of the marking device in an intermediary position as the marking device is being unfolded into an operational position, in accordance with an exemplary embodiment of the present invention.

### DETAILED DESCRIPTION OF THE INVENTION

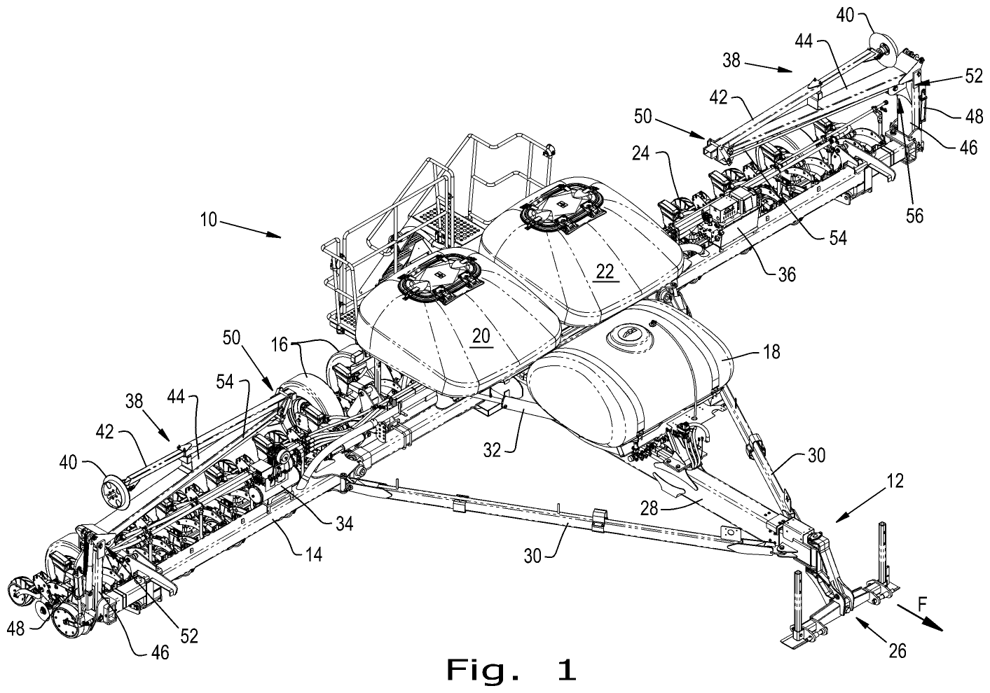

Referring now to the drawings, and more particularly to FIG. 1, there is shown an exemplary embodiment of an agricultural implement 10, shown in the form of an agricultural planter 10, formed in accordance with the present invention. The planter 10 may be connected to an agricultural vehicle, for example a tractor, or another implement pulled by the agricultural vehicle. The planter 10 generally includes a hitch assembly 12 at a front of the planter 10, a toolbar 14, main wheels 16, one or more storage tanks 18, 20, 22 that can be filled with seed or other agriculture material, such as fertilizer, and a plurality of row units 24 connected to the toolbar 14 and arranged laterally across the length of the toolbar 14. The hitch assembly 12 can include a hitch 26 which is configured for connecting to the tractor or other agricultural implement so that the planter 10 can be pulled in a forward direction “F”. The hitch 26 can be integrally formed with or connected to a center frame 28 that is connected to the toolbar 14 by bracing bars 30 and one or more actuators 32. The planter 10 can also have various hydraulic, pneumatic, and electrical lines (unnumbered) throughout in order to support various cylinders and systems that are included on the planter 10, such as a pneumatic system 34 connected to the toolbar 14 and an electric generator 36 which is also connected to the toolbar 14. Additionally, the planter 10 may also include at least one marking device 38, for example, a pair of marking devices 38 that are moveably connected to each lateral end of the toolbar 14. It should also be appreciated that the agricultural implement 10 may be in the form of any desired agricultural implement 10 such that the marking devices 38 may be incorporated as part of any desired agricultural implement 10.

Referring now collectively to FIGS. 1-3, there is shown the marking devices 38 of the planter 10 in greater detail. The marking devices 38 can create a line in the soil as the planter 10 is pulled in the forward direction F in order to help a user position the planter 10 for creating subsequent rows. Also, a respective marking device 38 marks a line at the next center line as the planter 10 turns around for the next pass. Each marking device 38 generally includes a marking disc 40 and one or more folding marker arm(s) 42, 44. As shown, each marking device 38 includes a first, outer arm 42 which rotationally connects to the disc 40 and a second, inner arm 44 pivotally connected to the outer arm 42 and supported by the toolbar 14. The inner arm 44 is configured for pivotally connecting to the planter 10 whereby the inner arm 44 can be pivotally connected to an extension arm 46 which in turn is coupled to the toolbar 14. The marking devices 38 may be individually, selectively folded into and out of a folded, stored position and an unfolded, operational position via one or more actuators 48, e.g. hydraulic or pneumatic cylinders, that are supported by the toolbar 14 and are respectively associated with each marking device 38. The arms 42, 44 may be composed of any desired material.

The marking devices 38 may also additionally include a first, outer attachment bracket 50, a second, inner attachment bracket 52, a kick out link 54 pivotally interconnected between the attachment brackets 50, 52, and a biasing member 56 connected to the kick out link 54. In the folded, stored position, the kick out link 54 acting in conjunction with the biasing member 56 inhibits an unwanted unfolding of the marking devices 38 such that the outer arms 42 do not become unfolded upon being tilted, jostled, subjected to an abrupt force and/or subjected to an inertial force.

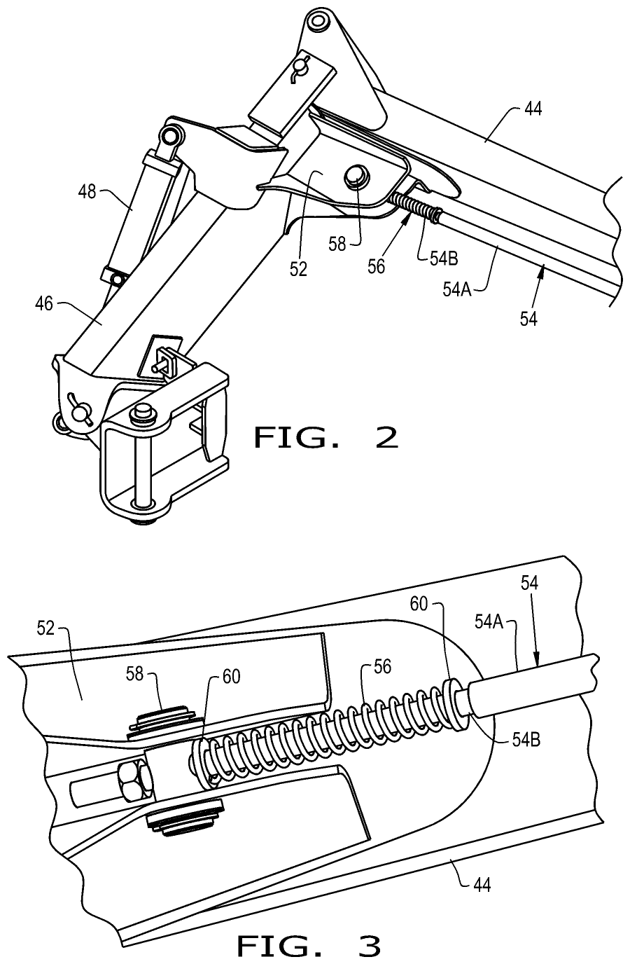

The outer attachment bracket 50 pivotally connects the outer and inner arms 42, 44 to one another. Thereby, the outer attachment bracket 50 connects all three of the outer arm 42, the inner arm 44, and the kick out link 54 relative to one another. The inner attachment bracket 52 is supported by the toolbar 14, fixedly mounted to the extension arm 46, and positioned adjacent to the proximal end of the second arm 44. The inner attachment bracket 52 may include a pin 58 pivotally coupled to the body of the inner attachment bracket 52 that in turn pivotally mounts the kick out link 54 (FIG. 2). The pin 58 thereby can define a pivot axis of the kick out link 54. Thus, the inner attachment bracket 52 may pivotally connect the kick out link 54 so that the kick out link 54 is substantially parallel with the inner arm 44. The attachment brackets 50, 52 may be in the form of any desired brackets and may be composed of any desired material.

The kick out link 54 is pivotally interconnected between the inner attachment bracket 52, adjacent to the proximal end of the inner arm 44, and the outer attachment bracket 50 at the distal end of the inner arm 44. The kick out link 54 is configured for controlling a movement of the outer arm 42. In other words, as the kick out link 54 slides relative to pin 58 to extend or retract, which correspondingly causes the kick out link 54 to unfold or fold into and out of the stored and operational positions. The kick out link 54 may have a first, outer link member 54A and a second, inner link member 54B. The outer link member 54A is connected to the outer attachment bracket 50, and the inner link member 54B is attached to the inner attachment bracket 52. In more detail, the inner link member 54B extends through a corresponding receiving hole in the pin 58, and a fastener (unnumbered) may keep the inner link member 54B from sliding out of the pin 58. When one or more of the actuator(s) 48 are activated to unfold the marking device(s) 38 into the operational position, the kick out link 54 is correspondingly moved, i.e., the inner link member 54B slides relative to the receiving hole in the pin 58 and the biasing member 56 is compressed. It should be appreciated that in an alternative embodiment, the outer link member 54A may be connected to the inner attachment bracket 52, and the inner link member 54B may be attached to the outer attachment bracket 50.

The biasing member 56 provides a biasing force acting on the kick out link 54 in order to retain the first arm 42 relative to the second arm 44 when the marking device 38 is in the stored position. The biasing member 56 is connected to the kick out link 54, and more particularly, the biasing member 56 is coupled to, e.g. fitted around, the inner link member 54B in between the pin 58 and an end of the outer link member 54A. For example, the biasing member 56 may be positioned in between a pair of stoppers 60, e.g. washers, connected to the inner link member 54B and positioned at each end of the biasing member 56 between the pin 58 and the outer link member 54A, respectively (FIG. 3). In the present embodiment, the biasing member 56 is in the form of a spring 56, for example a tension or compression coil spring. The spring 56 may apply a preload onto the kick out link 54. It should be appreciated that the biasing member 56 may not be in the form of a spring 56 but instead may be in the form of any desired biasing member such as an elastic member or an air spring (not shown). Additionally, there may be more than one biasing member 56, such as two or three biasing members 56, associated with each marking device 38.

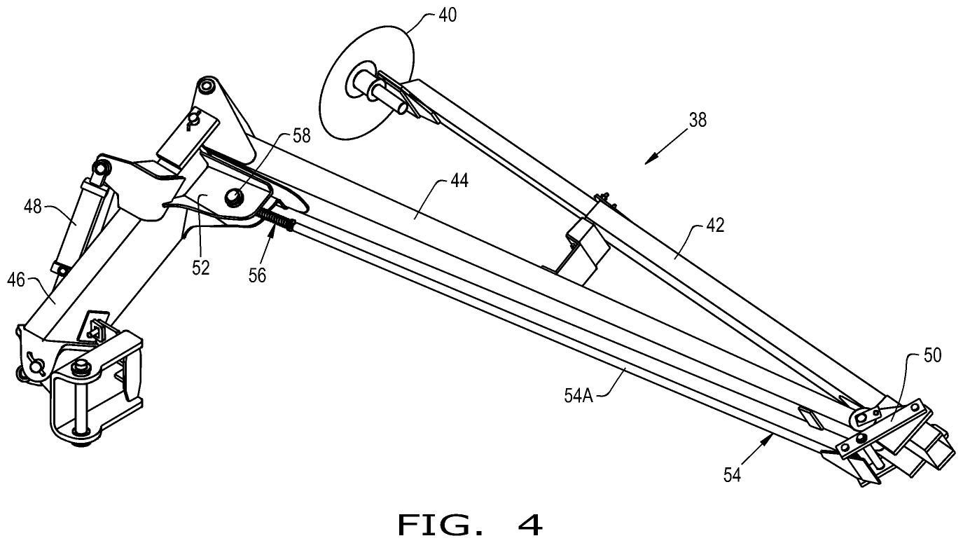

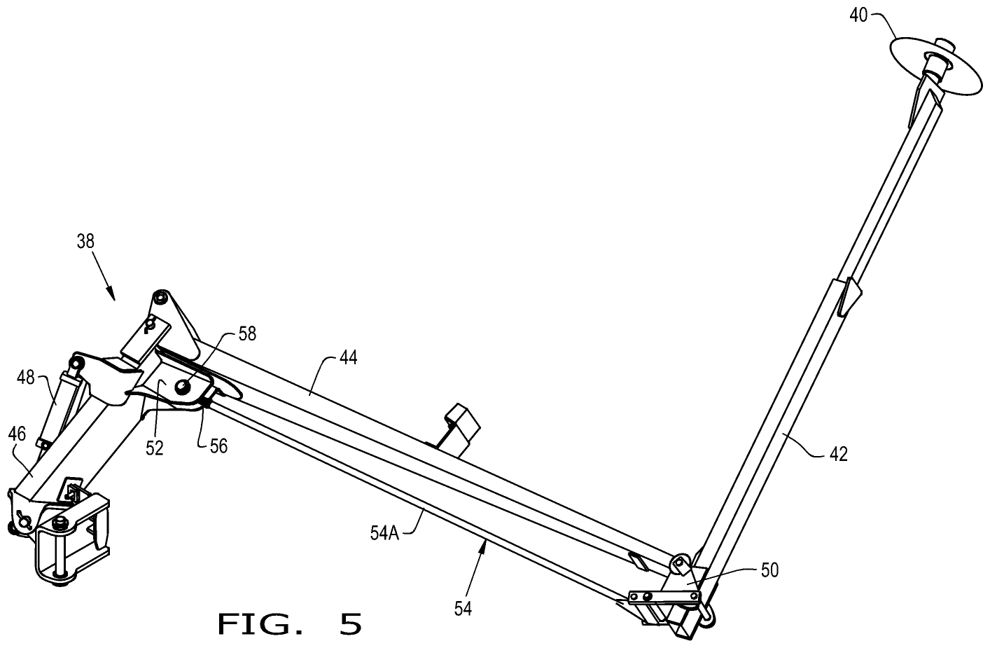

Referring now to FIGS. 4-5, there is shown a marking device 38 in the stored position (FIG. 4) and in an intermediary position (FIG. 5) as the marking device 38 is unfolding into the operational position. As shown in FIG. 4, the biasing member 56 preloads the kick out link 54 so that kick out link 54 does not slide relative to the pin 58. Unless and until the force acting on the outer link member 54A of the kick out link 54, applied via the actuator 48, overcomes the biasing force of the biasing member 56, the outer arm 42 will not unfold. In other words, a respective biasing member 56 prevents the unwanted movement of the respective outer arm 42, but the respective biasing member 56 does not prevent the desired unfolding of the marking device 38 from the stored position into the operational position when a respective actuator 48 is actuated automatically or by an operator. Further, as shown in FIG. 5, the biasing force of the biasing member 56 continues to act upon the kick out link 54 throughout the range of motion of the outer arm 42. In more detail, the biasing member 56 will remain uncompressed, or remain only slightly compressed, until the outer arm 42 is chosen to be unfolded, and upon unfolding, the outer link member 54A will abut against the biasing member 56, e.g. against stopper 60, and will continue to slide toward the pin 58, thereby substantially compressing the biasing member 56, as shown in FIG. 5. Alternatively, the outer link member 54A may contact and slightly compress the biasing member 56 in the folded, stored position, and the outer link member 54A may further compress the biasing member 56 in the unfolded, operational position. When the outer arm 42 is folded into the stored position, the outer link member 54A will slide away from the pin 58, the kick out link 54 will extend, and the biasing member 56 will become less compressed. Hence, the biasing member 56 dually prevents an undesired unfolding of the outer arm 42 and leads to a more controlled movement of the outer arm 42 during its operation.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. An implement for an agricultural vehicle, comprising:
a toolbar; and
a pair of marking devices pivotally connected to the toolbar, each said marking device including:
a first arm;
a second arm having a proximal end and a distal end;
a first attachment bracket pivotally connecting the first arm to the distal end of the second arm, and the first and second arms are configured for pivoting between a stored position in which the first and second arms are folded relative to one another and an operational position in which the first and second arms are unfolded relative to one another;
a second attachment bracket supported by the toolbar and positioned adjacent to the proximal end of the second arm;
a kick out link pivotally interconnected between the first attachment bracket and the second attachment bracket, the kick out link is configured for controlling a movement of the first arm; and
a biasing member connected to the kick out link and configured for providing a biasing force acting on the kick out link to retain the first arm relative to the second arm in the stored position.

2. The implement of claim 1, wherein the biasing member is in the form of a spring and the spring applies a preload onto the kick out link.

3. The implement of claim 1, wherein, in the stored position, the biasing members of the marking devices inhibit the movement of the first arms such that the first arms are prevented from undesirably unfolding upon being at least one of tilted, jostled, subjected to an abrupt force and subjected to an inertial force.

4. The implement of claim 3, further including a pair of actuators supported by the toolbar, respectively associated with each marking device, and configured for unfolding and folding each marking device between the stored and operational positions, wherein a respective kick out link of a respective marking device does not slide, in order to unfold the first arm, until a force acting on the kick out link, applied via a respective actuator, overcomes the biasing force of the biasing member.

5. The implement of claim 1, wherein the second attachment bracket includes a pin which pivotally mounts the kick out link.

6. The implement of claim 5, wherein the kick out link includes an outer link member and an inner link member, and the outer link member is connected to the first attachment bracket and the inner link member is attached to the pin of the second attachment bracket.

7. The implement of claim 6, wherein the biasing member is coupled to the inner link member in between the pin and the outer link member.

8. The implement of claim 7, wherein each marking device further includes a first stopper and a second stopper respectively connected to the inner link member, the first stopper is positioned in between the outer link member and the biasing member and the second stopper is positioned in between the biasing member and the pin.

9. A marking device pivotally connected to an implement for an agricultural vehicle, comprising:
a first arm;
a second arm having a proximal end and a distal end;
a first attachment bracket pivotally connecting the first arm to the distal end of the second arm, and the first and second arms are configured for pivoting between a stored position in which the first and second arms are folded relative to one another and an operational position in which the first and second arms are unfolded relative to one another;
a second attachment bracket positioned adjacent to the proximal end of the second arm;
a kick out link pivotally interconnected between the first attachment bracket and the second attachment bracket, the kick out link is configured for controlling a movement of the first arm; and
a biasing member connected to the kick out link and configured for providing a biasing force acting on the kick out link to retain the first arm relative to the second arm in the stored position.

10. The marking device of claim 9, wherein the biasing member is in the form of a spring and the spring applies a preload onto the kick out link.

11. The marking device of claim 9, wherein, in the stored position, the biasing member of the marking device inhibits the movement of the first arm such that the first arm is prevented from undesirably unfolding upon being at least one of tilted, jostled, subjected to an abrupt force and subjected to an inertial force.

12. The marking device of claim 9, wherein the second attachment bracket includes a pin which pivotally mounts the kick out link.

13. The marking device of claim 12, wherein the kick out link includes an outer link member and an inner link member, and the outer link member is connected to the first attachment bracket and the inner link member is attached to the pin of the second attachment bracket.

14. The marking device of claim 13, wherein the biasing member is coupled to the inner link member in between the pin and the outer link member.

15. The marking device of claim 14, further including a first stopper and a second stopper respectively connected to the inner link member, the first stopper is positioned in between the outer link member and the biasing member and the second stopper is positioned in between the biasing member and the pin.

16. A method, comprising the steps of:
providing an implement for an agricultural vehicle including a toolbar and a pair of marking devices pivotally connected to the toolbar, each said marking device including a first arm, a second arm having a proximal end and a distal end, a first attachment bracket pivotally connecting the first arm to the distal end of the second arm, and the first and second arms are configured for pivoting between a stored position in which the first and second arms are folded relative to one another and an operational position in which the first and second arms are unfolded relative to one another, a second attachment bracket supported by the toolbar and positioned adjacent to the proximal end of the second arm, a kick out link pivotally interconnected between the first attachment bracket and the second attachment bracket, the kick out link is configured for controlling a movement of the first arm, and a biasing member connected to the kick out link and configured for providing a biasing force acting on the kick out link;
biasing, by the biasing member, the kick out link to not slide in order to retain the first arm relative to the second arm in the stored position; and
overcoming, by the kick out link, the biasing force provided by the biasing member upon selecting to unfold a respective marking device to be in the operational position.

17. The method of claim 16, wherein the biasing member is in the form of a spring and the spring applies a preload onto the kick out link.

18. The method of claim 16, wherein, in the stored position, the biasing members of the marking devices inhibit the movement of the first arms such that the first arms are prevented from undesirably unfolding upon being at least one of tilted, jostled, subjected to an abrupt force and subjected to an inertial force.

19. The method of claim 16, wherein the second attachment bracket includes a pin which pivotally mounts the kick out link, and the kick out link includes an outer link member and an inner link member, and the outer link member is connected to the first attachment bracket and the inner link member is attached to the pin of the second attachment bracket.

20. The method of claim 19, wherein the biasing member is coupled to the inner link member in between the pin and the outer link member.
